(19) United States
(12) Patent Application Publication
(10) Pub. No.: US 2005/0210426 A1
(43) Pub. Date: Sep. 22, 2005

(54) System and method to prioritize and selectively apply configuration information for VLSI circuit analysis tools

(76) Inventors: S. Brandon Keller, Evans, CO (US); Gregory Dennis Rogers, Ft. Collins, CO (US); George Harold Robbert, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/803,610

(22) Filed: Mar. 18, 2004

(51) Int. Cl. G06F 17/50; G06F 9/455

(52) U.S. Cl. 716/4; 716/11

(57) ABSTRACT

A method for use by a circuit analysis tool for selectively applying configuration information from multiple sources to configuration data elements (“CDEs”) stored in a database is described. The method comprises comparing a data source indicator (“DSI”) of a configuration command with a DSI of a corresponding CDE; if the DSI of the configuration command takes precedence over the DSI of the corresponding CDE, applying the configuration command thereto; and if the DSI of the configuration command does not take precedence over the DSI of the corresponding CDE, disregarding the configuration command.

### CROSS-REFERENCE TO RELATED APPLICATIONS

This application is related to the following commonly-owned, co-pending U.S. patent applications: U.S. patent application Ser. No. ______, filed ______ entitled “SYSTEM AND METHOD TO OPTIMIZE LOGICAL CONFIGURATION RELATIONSHIPS IN VLSI CIRCUIT ANALYSIS TOOLS” (Docket No. 200311735-1); U.S. patent application Ser. No. ______, filed ______ entitled “SYSTEM AND METHOD FOR FACILITATING EFFICIENT APPLICATION OF LOGICAL CONFIGURATION INFORMATION IN VLSI CIRCUIT ANALYSIS TOOLS” (Docket No. 200311736-1); U.S. patent application Ser. No. ______, filed ______ entitled “SYSTEM AND METHOD FOR FLATTENING HIERARCHICAL DESIGNS IN VLSI CIRCUIT ANALYSIS TOOLS” (Docket No. 200311777-1); U.S. patent application Ser. No. ______ filed ______ entitled “SYSTEM AND METHOD FOR CONTROLLING ANALYSIS OF MULTIPLE INSTANTIATIONS OF CIRCUITS IN HIERARCHICAL VLSI CIRCUIT DESIGNS” (Docket No. 200311778-1); and U.S. patent application Ser. No. ______, filed ______ entitled “SYSTEM AND METHOD TO LIMIT RUNTIME OF VLSI CIRCUIT ANALYSIS TOOLS FOR COMPLEX ELECTRONIC CIRCUITS” (Docket No. 200311780-1); all of which are hereby incorporated by reference in their entirety.

### BACKGROUND

In the field of integrated circuit (“IC”) design and particularly very large scale integration (“VLSI”) design, it is desirable to test the design before implementation and to identify potential violations in the design. Before implementation on a chip, the information about a design, including information about specific signals and devices that comprise the design, as well as information about connections between the devices, are typically stored in a computer memory. Based on the connection and device information, the designer can perform tests on the design to identify potential problems. For example, one portion of the design that might be tested is the conducting material on the chip. In particular, representations of individual metal segments may be analyzed to determine whether they meet certain specifications, such as electromigration and self-heating specifications. Other tests that may be conducted include electrical rules checking tests, such as tests for noise immunity and maximum driven capacitance, and power analysis tests that estimate power driven by a particular signal and identify those over a given current draw. These tests may be performed using software tools referred to as VLSI circuit analysis tools.

Modern semiconductor IC chips include a dense array of narrow, thin-film metallic conductors, referred to as “interconnects”, that transport current between various devices on the IC chip. As the complexity of ICs continues to increase, the individual components must become increasingly reliable if the reliability of the overall IC is to be maintained. Due to continuing miniaturization of VLSI circuits, thin-film metallic conductors are subject to increasingly high current densities. Under such conditions, electromigration can lead to the electrical failure of interconnects in a relatively short period of time, thus reducing the lifetime of the IC to an unacceptable level. It is therefore of great technological importance to understand and control electromigration failure in thin film interconnects.

Electromigration can be defined as migration of atoms in a metal interconnect line due to momentum transfer from conduction electrons. The metal atoms migrate in the direction of current flow and can lead to failure of the metal line. Electromigration is dependent on the type of metal used and correlates to the melting temperature of the metal. In general, a higher melting temperature corresponds to higher electromigration resistance. Electromigration can occur due to diffusion in the bulk of the material, at the grain boundaries, or on the surface. For example, electromigration in aluminum occurs primarily at the grain boundary due to the higher grain boundary diffusivity over the bulk diffusivity and the excellent surface passivation effect of aluminum oxide that forms on the surface of aluminum when it is exposed to oxygen. In contrast, copper exhibits little electromigration in the bulk and at the grain boundary and instead primarily exhibits electromigration on the surface due to poor copper oxide passivation properties.

Electromigration can cause various types of failures in narrow interconnects, including void failures along the length of a line and diffusive displacements at the terminals of a line that destroy electrical contact. Both types of failure are affected by the microstructure of the line and can therefore be delayed or overcome by metallurgical changes that alter the microstructure. As previously noted, electromigration is the result of the transfer of momentum from electrons moving in an applied electric field to the ions comprising the lattice of the interconnect material. Specifically, when electrons are conducted through a metal, they interact with imperfections in the lattice and scatter. Thermal energy produces scattering by causing atoms to vibrate; the higher the temperature, the more out of place the atom is, the greater the scattering, and the greater the resistivity. Electromigration does not occur in semiconductors, but may in some semiconductor materials that are so heavily doped as to exhibit metallic conduction.

The driving forces behind electromigration are “direct force”, which is defined as the direct action of the external field on the charge of the migrating ion, and “wind force”, which is defined as the scattering of the conduction electrons by the metal atom under consideration. For simplicity, “electron wind force” often refers to the net effect of these two electrical forces. This simplification will also be used throughout the following discussion. These forces and the relation therebetween are illustrated in FIG. 1.

The electromigration failure process is predominantly influenced by the metallurgical-statistical properties of the interconnect, the thermal accelerating process, and the healing effects. The metallurgical-statistical properties of a conductor film refer to the microstructure parameters of the conductor material, including grain size distribution, the distribution of grain boundary misorientation angles, and the inclinations of grain boundaries with respect to electron flow. The variation of these microstructural parameters over a film causes a non-uniform distribution of atomic flow rate. Non-zero atomic flux divergence exists at the places where the number of atoms flowing into the area is not equal to the number of atoms flowing out of that area per unit time such that there exists either a mass depletion (divergence>0) or accumulation (divergence<0), leading to formation of voids and hillocks, respectively. In such situations, failure results either from voids growing over the entire line width, causing line breakage, or from extrusions that cause short circuits to neighboring lines.

The thermal accelerating process is the acceleration process of electromigration damage due to a local increase in temperature. A uniform temperature distribution along an interconnect is possible only absent electromigration damage. Once a void is initiated, it causes the current density to increase in the area around the void due to the reduction in the cross-sectional area of the conductor. The increase of the local current density is referred as “current crowding.” Since joule heating, or “self-heating”, is proportional to the square of current density, the current crowding effect leads to a local temperature rise around the void that in turn further accelerates the void growth. The whole process continues until the void is large enough to result in a line break.

Healing effects are the result of atomic flow in the direction opposite to the electron wind force, i.e., the “back-flow,” during or after electromigration. The back-flow of mass is initiated once a redistribution of mass has begun to form. Healing effects tend to reduce the failure rate during electromigration and partially heals the damage after current is removed. Nonhomogenities, such as temperature and/or concentration gradients, resulting from electromigration damage are the cause of the back-flow.

The effects of electromigration may be slow to develop; however, if an electromigration problem exists, the progress toward a fault is inexorable. The results of an electromigration problem are illustrated in FIGS. 2 and 3. Before current is applied to a section of an IC chip that is first powered up, the metal comprising the interconnects thereof is uniformly distributed, as illustrated in FIG. 2, which illustrates a side view of an interconnect 200. However, in a section of metal that is at risk for electromigration, the mass transport of metal, which occurs in the direction of average current, represented in FIG. 3 by an arrow 301, results in metal moving from a first end 302a of the section to a second end 302b thereof. At some future time, depending on the amount of current flowing through and the thickness of the interconnect 200, electromigration will result in the formation of a void 304 at the first end 302a and a hillock 304 at the second end 302b. Eventually, as previously described, this migration of metal from one end of the wire to the other will result in a failure of the interconnect 200.

As also previously noted, self-heating contributes to the electromigration and actually affects the surrounding wires as well. As a wire carries current, it will heat up, thereby lowering the limits for electromigration in surrounding wires as well as the wire under consideration. It is important, therefore, to consider the effects of both electromigration and self-heating (collectively “EM/SH”) when analyzing and verifying the reliability of an IC chip design.

Typically, circuit analysis tools (including, e.g., the EM/SH analysis tools) are provided to be configurable in order to optimize the tool performance as well as accommodate different application environments. Particularly, as VLSI designs continue to increase in complexity, it becomes even more critical that the tools be configured properly for proper operation. When a circuit analysis tool is configured using configuration information from multiple sources, it is often necessary to prioritize such information so as to obtain optimal performance. Also, it would be beneficial for the configuration information to be able to facilitate different modes of analysis on the same IC design.

### SUMMARY

One embodiment is a method for use by a circuit analysis tool for selectively applying configuration information from multiple sources to configuration data elements (“CDEs”) stored in a database. The method comprises comparing a data source indicator (“DSI”) of a configuration command with a DSI of a corresponding CDE; if the DSI of the configuration command takes precedence over the DSI of the corresponding CDE, applying the configuration command thereto; and if the DSI of the configuration command does not take precedence over the DSI of the corresponding CDE, disregarding the configuration command.

### BRIEF DESCRIPTION OF THE DRAWINGS

FIG. 1 illustrates the driving forces behind electromigration, including direct force and wind force;

FIGS. 2 and 3 illustrate the effects of electromigration on an IC chip interconnect;

FIG. 4 is a flow diagram of a reliability verification tool (“RVT”) in one embodiment;

FIG. 5 is a block diagram of one embodiment of a VLSI circuit analysis tool;

FIG. 6 is a flowchart of the operation of one aspect of the VLSI circuit analysis tool of FIG. 5;

FIG. 7 is a flowchart of the operation of another aspect of the VLSI circuit analysis tool of FIG. 5; and

FIG. 8 is a flowchart of the operation of yet another aspect of the VLSI circuit analysis tool of FIG. 5.

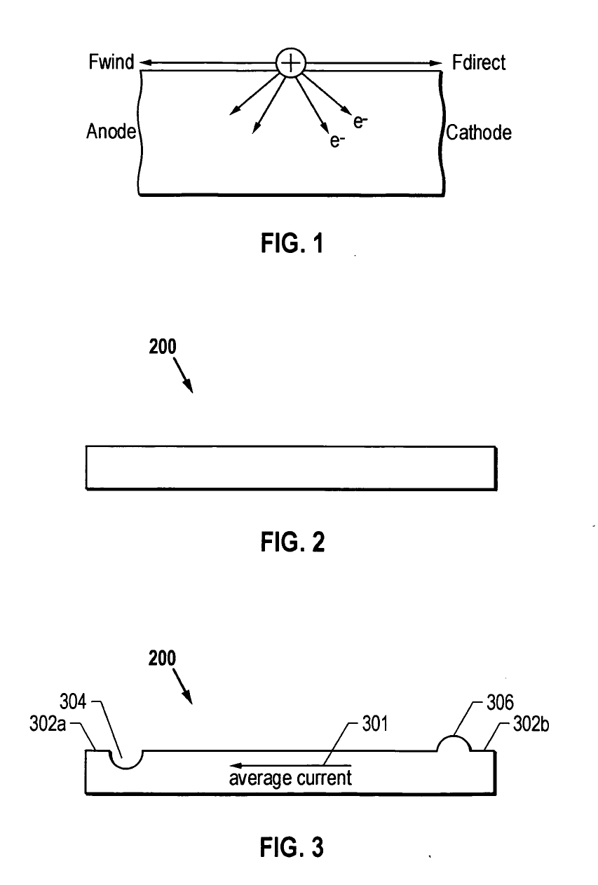

### DETAILED DESCRIPTION OF THE DRAWINGS

In the drawings, like or similar elements are designated with identical reference numerals throughout the several views thereof, and the various elements depicted are not necessarily drawn to scale.

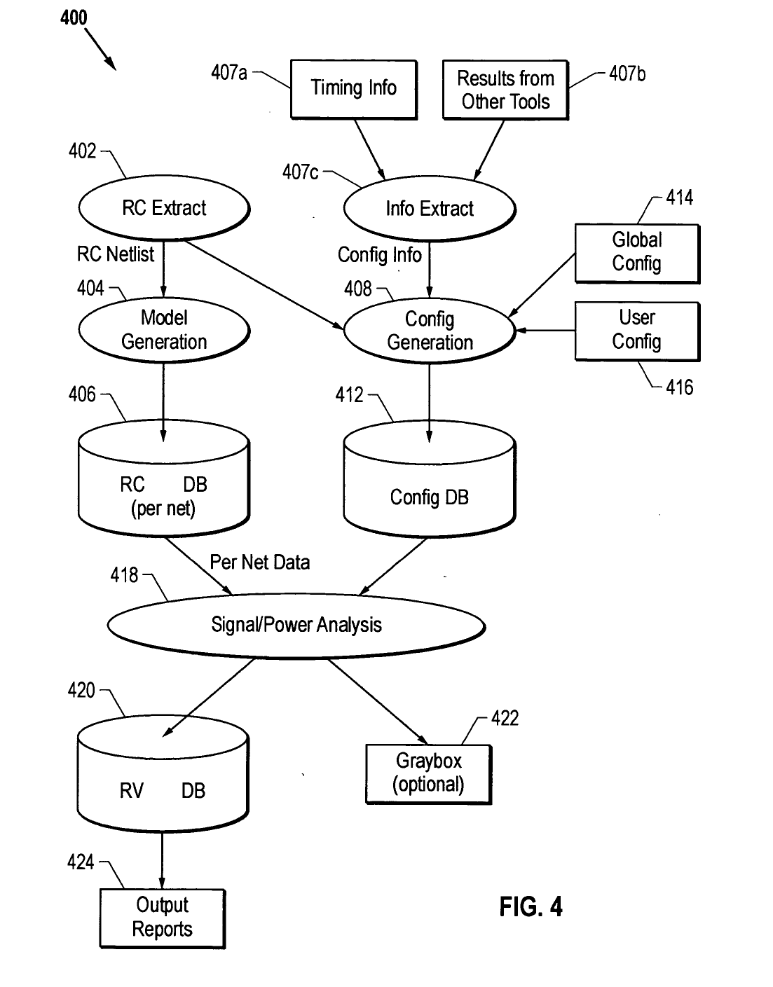

FIG. 4 is a flow diagram of one embodiment of a VLSI circuit analysis tool, specifically, a reliability verification tool (“RVT”) 400. In the illustrated embodiment, the RVT 400 is designed to find areas of an IC block layout that may have electromigration and/or self-heating (“EM/SH”) risks. The output files produced by the RVT 400 are useful for viewing violations in a text manner and a violations shapes representation can be loaded on top of the block artwork to provide a visual representation of the problem areas and the changes proposed by the RVT 400 to correct those problems.

Specifically, the RVT 400 is designed to assist designers with the challenging task of identifying potential EM/SH problem areas in their designs. Since the rules of electromigration are not always intuitive and problem areas can be hard to spot, the RVT 400 is an important tool for determining if the design has any violations that, if not discovered and corrected, could lead to future chip failure. This is due to the fact that faults that electromigration can produce develop slowly over time until the metal finally breaks.

In one embodiment, the RVT 400 provides a designer with a clear, easy-to-follow approach to identifying EM/SH violations. Theoretically, design rules should prevent most wires from risk of electromigration, but cases still exist in which there may be a problem. By running the RVT 400 on a design block, a designer can ensure that the wires in the block will be reliable in the long term and will not cause a chip failure. The RVT 400 accomplishes this by calculating the currents through each piece of metal and each contact array on the chip. It compares these currents with certain process rules describing the maximum current that a given width of metal or set of contacts may carry. Any currents that do not meet the limits are reported as violations.

In order to “calculate the currents”, as indicated above, the RVT 400 may be run in either “signal” or “power” mode to analyze metal connecting signals or to analyze the power grid. These two runs are performed separately to give better capacity and performance. In signal analysis, the RVT 400 first separates the chip into individual stages. A stage is a set of resistors that connect one or more driver FETs (i.e., those FETs that are connected to a supply) to the gates of one or more receiver FETs. These connections may pass through the channels of any number of pass FETs in the process. The RVT 400 takes each of these stages and attempts to simulate the likely combinations of on and off FETs, as dictated by logic configuration, taking the worst case currents determined over all of the simulations. The currents are then checked against the EM/SH rules.

In power analysis, the RVT 400 treats each power grid rail as its own stage. It uses the current through FETs connected to the rail determined in a previous signal analysis run to load the power grid. After simulating the grid with the load currents, it checks the currents calculated through each resistor against the EM/SH rules.

FIG. 4 illustrates the overall flow of data and control through the RVT 400. The diagram illustrated in FIG. 4 illustrates the flow that applies to both signal and power analysis. The RVT 400 relies on a special RC extract 402 to perform its analysis. In one embodiment, the RC extract 402 provides highly detailed resistance values to enable the EM/SH rules to be applied correctly.

A Model Generation module 404 processes the extracted RC information from the RC extract 402 into an RC database (“DB”) 406 for each block. This allows easy access of the information on a per-net basis so that only the nets for a particular stage, as opposed to the entire model, need to be loaded into memory. The RC DB 406 is reused from run to run of the RVT 400 and is only regenerated when a new extract is performed.

The RVT 400 also relies on configuration information, such as timing information 407a and results from other analysis tools 407b, extracted from other sources by an info extract module 407c. These sources produce configuration files that, once extracted, are read in by a configuration generation phase 408 of the RVT 400. As previously noted, the extracted configuration information input to the configuration generation phase 408 may include information extracted from circuit annotation, timing information and additional circuit properties from transistor-level static timing analysis tool runs, information extracted from circuit recognition, and node activity factor (“AF”) information.

In one embodiment, as indicated above, the RVT 400 has the ability to read some configuration information pertaining to logical relationships within the design, such as those logic configuration commands listed below. These commands may be specified via configuration files or via annotations directly associated with schematic representations of the design. Each of the block properties' values is a list of signal names, each of which may be prefixed by “!”, indicating the opposite logic sense should be applied to that signal. The block properties include:

| | |
|---|---|
| set_high | instructs the analysis tool to set the specified net(s) |
| | to logic 1 |
| set_low | instructs the analysis tool to set the specified net(s) |
| | to logic 0 |
| unset | instructs the analysis tool to that any previous |
| | set_high or set_low information should be removed |
| | from the specified net(s) |
| merge_nodes | instructs the analysis tool to treat all of the |
| | specified nets as having the same logical value |
| mutex | instructs the analysis tool that exactly one of the |
| | specified nets should have a value of 1 |
| imutex | instructs the analysis tool that no more than one of |
| | the specified nets should have a value of 1 |
| ifthen | instructs the analysis tool as to the logical |
| | relationship of nets based on the state of the first |
| | net |
| forbid | forbids the specified combination of nets |

In one embodiment, as also indicated above, the RVT 400 has two methods for determining the activity factor on nodes. Both of these may be overridden by user configuration information if desired. The first such method is to use the default activity factors according to the node's type as determined by circuit recognition and a transistor-level static timing analysis tool. The second is to read explicit activity factors for each node. This can either specify a user-created file for activity factors or it may run some other tool to generate activity factors. If this method is selected, any node that does not have an activity factor explicitly specified therefore will default to one based on node type.

Similar to the Model Generation module 404, the Configuration Generation module 408 consolidates all of the configuration information at the beginning of a run and places this in a Config DB 412 for easy per-net access. The Configuration Generation module 408 reads a global configuration file 414 specified by a tool administrator and a user configuration file 416 specified by a user on a per-block basis. Both of these configuration files 414, 416, may be used to override the extracted configuration if necessary.

In addition to combining all of the configuration information together in a per-net fashion, the Configuration Generation module 408 also propagates some logic configuration through a process referred to as “transitive closure”, as described in related U.S. patent application Ser. No. ______ (Docket No. 200311735-1), which has been incorporated by reference in its entirety.

A signal/power analysis module 418 performs the main work of the RVT 400. It handles one stage at a time, calculating the currents through each resistor and applying the EM/SH rules. It generates both a Reliability Verification database (“RV DB”) 420, which contains all of the information it calculates, and an optional “graybox” description 422 for the file. The RV DB 420 is subsequently processed to generate the various output reports that users actually read. In order to improve performance, the analysis may be run on serval machines in parallel. As each stage is independent, requiring only the information on the nets it contains, the analysis is easily parallelizable.

It should be noted that when the RVT 400 generates a graybox 422 for a given block, it will create both a netlist, or “BDL”, file and also a config file containing all configuration information for the ports of the graybox. This allows various configuration (such as node types or activity factors) to be propagated up from a graybox. The graybox information is read in by the Model Generation module 404 and the Configuration Generation module 410 when the graybox 422 is used in the analysis of a parent block.

The RVT 400 generates a variety of output reports 424 such as a text file containing a list of all resistors that failed the EM/SH rules, along with any stages that were discarded. The RVT 400 also generates layout shapes that highlight the violations at each level of the hierarchy. The violations shapes are all stored as blocks along with the rest of the output files 424.

Running a power analysis using the RVT 400 relies on the user to have previously run a signal analysis with the RVT at or above the level on which a power analysis is to be run. During the RVT signal analysis, the default is to write out the average case and worst case current through all driver FETs (i.e. any FETs with a source or drain of VDD or GND) to a “signal_rvdb” file so that power analysis can use those currents. This also includes writing currents through output drivers, which means that these stages are analyzed for currents, but no EM/SH checks are done on those stages and no resistor currents are reported for them.

The average and worst case currents are calculated in the signal run as follows. The worst case current is simply the worst case current through each driver FET seen during the signal run using the same activity factors (“AF”) and drive fights (“DF”) signal run. This current will be used in the worst case RVT power analysis, which is performed on the low level metal and via layers as specified in the global configuration file 414.

Calculating the average case current is a bit more complicated. The average case current is used to check EM/SH on the upper level metal and via layers as specified in the global configuration file 414, thus it is very important to get the current for the entire stage correct and not as important to get the current for each driver FET correct. Thus, for the average case power analysis, it is not advisable to use the worst case current. The global configuration file 414 may also specify different default activity factors for different node types to use with power analysis. For example, changing the default activity factor for static nodes to 0.2 instead of using the 0.5 used for worst case signal analysis, more accurately represents the power drawn.

During an RVT power analysis run, the RVT 400 collects the driver FET currents calculated during the RVT signal run, as described above, generates a power SPICE deck, simulates that deck, checks each resistor in the simulated grid against EM/SH rules, and generates output files, including violations files, and power grayboxes if requested to do so.

As previously described, configuration data may be input to the RVT 400 from a variety of sources. In one aspect of the illustrated embodiment, those configuration data sources may be prioritized with respect to a single IC design. In this aspect, as configuration data is read into a VLSI circuit analysis tool, such as the RVT 400, from each configuration data source, the data is tagged with a source indicator. Thus, each configuration command may be stored in a data structure that takes the form:
[Configuration Command]
[Data source indicator]
[Configuration modifier]

The “Data source indicator” indicates the data source from which configuration data is derived. The “Configuration modifier” identifies a configuration data element, stored in the Config DB 412 (FIG. 4) to which the command is to be applied as well as the configuration data value associated with the configuration data element. Each configuration command may have a default source, for example, “none”, meaning that no configuration information was specified for that particular configuration command. Configuration commands may apply to any element of a VLSI circuit design. A VLSI circuit analysis tool can use these configuration command structures to determine default values to use during an analysis and also to establish a hierarchy of precedence based on the data source indicator.

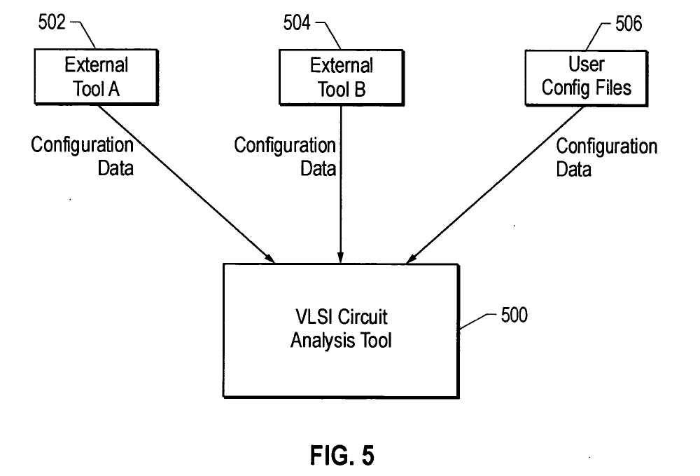

Referring to FIG. 5, consider a VLSI circuit analysis tool 500, which may be, for example, an RVT such as the RVT 400, to which configuration data is input from several sources, including a first external tool (“external_tool_A”) 502, a second external tool (“external_tool_B”) 504, and user configuration files (“user”) 506. According to a pre-established prioritization, which may be dictated by an administrator of the tool 500, the configuration data source user 506 has the highest priority and the configuration data source external_tool_B 504 has the lowest priority among the three configuration data sources 502, 504, 506. It will be assumed for the sake of example that the following configuration commands are read by the tool 500 in the illustrated order:
data_source external_tool_A
wire_capacitance net_a 13 pF
data_source external_tool_B
wire_capacitance net_a 27 pF
data_source user
wire_capacitance net_a 15 pF

It will be recognized that although only three configuration data sources are illustrated in FIG. 5, more or fewer such sources may be used to provide configuration data to the tool 500.

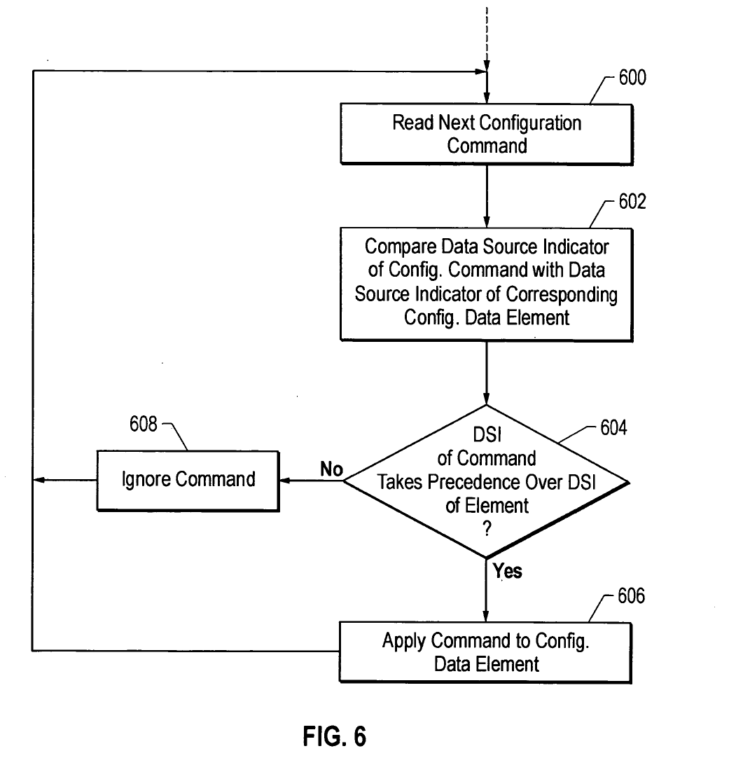

A flowchart of the operation of the tool 500 in accordance with one embodiment is illustrated in FIG. 6. In 600, the next configuration command is read. In step 602, the data source indicator of the configuration command is compared with the data source indicator of the corresponding configuration data element. In step 604, a determination is made whether the data source identified by the data source indicator of the configuration command takes precedence over the data source identified by the data source indicator of the configuration data element. If so, execution proceeds to step 606, in which the configuration command is applied to the configuration data element; otherwise, execution proceeds to step 608, in which the configuration command is ignored. From either step 606 or step 608, execution returns to step 600, in which the next configuration command is read.

Applying the flowchart illustrated in FIG. 6 to the example set forth hereinabove, and assuming the three configuration commands are the first three configuration commands read by the tool 500, in step 600, the command:
data_source external_tool_A
wire_capacitance net_a 13 pF
   is read by the tool 500. In step 602, the data source of that command (i.e., external_tool_A) is compared with that of the identified configuration data element (wire_capacitance net_a) (assumed to be “none”) as currently stored in the Config DB 412 (FIG. 4). In step 604, it is determined that the data source of the command takes precedence over that of the configuration data element, so execution proceeds to step 606. In step 606, the configuration command is applied to the identified configuration data element and the value of wire_capacitance net_a becomes 13 pF. Execution then returns to step 600, in which the next command:
data_source external_tool_B
wire_capacitance net_a 15 pF
   is read by the tool 500. In step 602, the data source of the command (i.e., external_tool_B) is compared with that of the configuration data element (i.e., external_tool_A) as currently stored in the Config DB 412. In step 604, it is determined that the data source of the command does not have a higher precedence than that of the data element; therefore, execution proceeds to step 608. In step 608, the command is ignored and the value of wire_capacitance net_a remains 13 pF.

Returning again to step 600, the next configuration command:
data_source user
wire_capacitance net_a 27 pF
   is read by the tool 500. In step 602, the data source of the command (i.e., user) is compared with that of the configuration data element (i.e., external_tool_A). In step 604, it is determined that the data source of the command does have a higher precedence than that of the data element; therefore, execution proceeds to step 606. In step 606, the command is applied to the configuration data element and the value of wire_capacitance net_a becomes 27 pF.

The above is a fairly simple example, but it can be extended to various situations in an analysis tool where defaults must be generated. For example, suppose that a VLSI circuit analysis tool utilizes slope data on the input and output of a logic gate to determine crossover current for the gate. If configuration data exists on the input and output of the gate, but the analysis tool has the ability to estimate an output slope based on a given input slope, the precedence rules for the configuration elements can determine whether the analysis tool should simply estimate the output slope, in which case the input slope configuration data will have a higher precedence than the output configuration data, or simply leave both configuration data elements unmodified.

Conventional VLSI circuit analysis tools simply read configuration information in a defined order, with later configuration commands superceding earlier ones. The process illustrated in FIG. 6 allows a priority, or precedence, to be established by a tool administrator such that later configuration commands may or may not supercede earlier ones, depending on the source thereof.

In another aspect, given a set of configuration commands that may be provided to configure the analysis of the VLSI circuit analysis tool 500, which may comprise an RVT such as the RVT 400, different configurations may be used, depending on a user-specified “case” of analysis to perform. In this aspect, a “case” modifier is be provided as a prefix to a configuration command that is only to be applied to a given case. For example, the following configuration command:
wire_capacitance net_a 32 fF
   would apply to any analysis case performed by the tool 500. In contrast, the following configuration command:
case test1 wire_capacitance net_a 25 fF
   would make the new value (25 fF) apply only in the case “test1”. In this manner, a user may create default values (e.g., 32 fF) for all cases and then create specific configuration values (e.g., 25 fF) that specializes the behavior of the analysis tool for a specified case.

In operation, a user of the analysis tool indicates a particular case that should be analyzed and the analysis tool reads through any provided configuration information and discards any elements that are specified with a case that is not equivalent to the user-specified case. Any configuration commands that do not have a case modifier are retained, as such commands represent default values that apply to all cases.

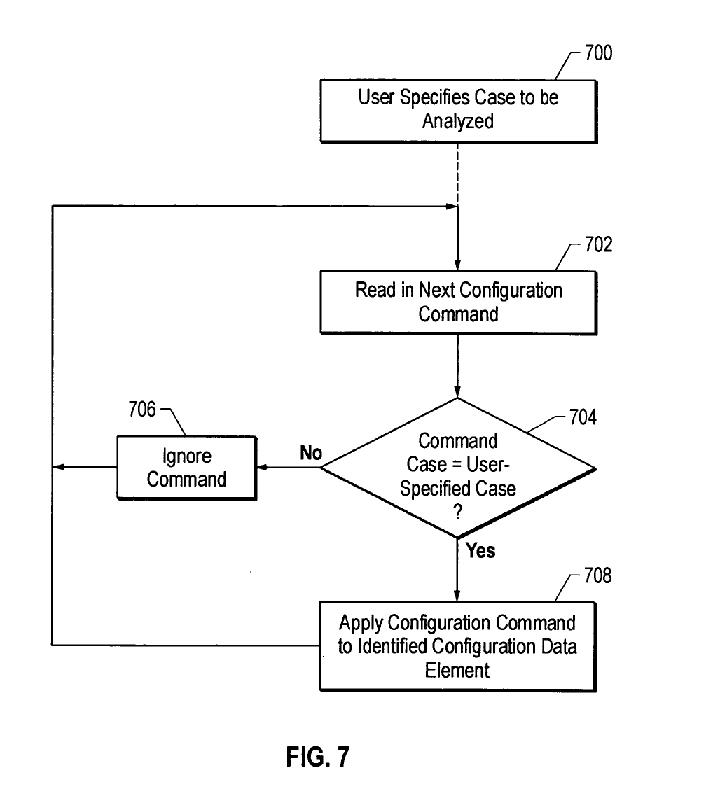

Operation of this aspect of the tool 500 is illustrated in FIG. 7. In step 700, the user specifies a case to be analyzed. Sometime later, in step 702, a configuration command is read. In step 704, a determination is made whether the case of the configuration command is the same as the user-specified case. If not, execution proceeds to step 706, in which the command is ignored. If a positive determination is made in step 704, execution proceeds to step 708, in which the command is applied to the identified configuration data element. Upon completion of either step 706 or 708, execution returns to step 702 and this process is repeated until all of the configuration commands have been considered.

Conventional VLSI circuit analysis tool configuration is specific to a single case of analysis and different configuration files must be used to enable multiple case analysis. The above-described feature enables users to create a single configuration file that contains all of the configuration information for all cases of analysis. Clearly, this is more convenient and provides improved readability and understanding of the various analysis cases and their associated configuration.

In yet another aspect, an embodiment of the analysis tool 500 enables users to remove unwanted configuration data from their analysis runs without specifically overriding the configuration data with a new specific value. The analysis tool 500 keeps track of the order in which configuration information is read and deletes configuration information that is overridden by a later configuration command, indicating that previous instantiations of the command should be ignored. This feature is intended to be used within an analysis tool that stores configuration information separately from data model information, such as is the case with the RVT 400, so that configuration information may be easily deleted.

The following example is provided to illustrate the feature:
==Global Configuration File==
wire_capacitance net_a 10 fF
==User's Local Configuration File==
no wire_capacitance net_a
   In the illustrated example, the user has opted not to use the global configuration for net_a, instead relying on the data model (perhaps the result of an RC extraction) to determine the wire capacitance for the net.

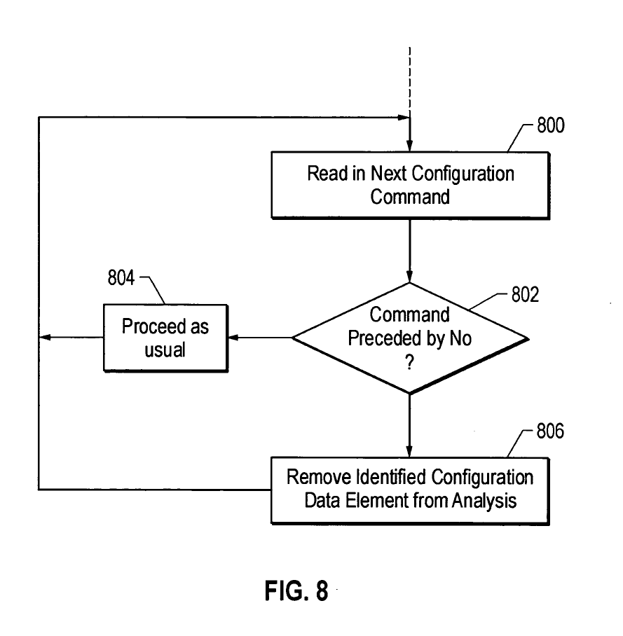

FIG. 8 illustrates operation of the tool 500 for implementing the above-described feature. For each configuration command that is read by the tool 500 (step 800), in step 802, a determination is made whether the configuration command is preceded by a “no” prefix. If not, execution proceeds as usual in step 804; otherwise, the identified configuration data element is removed from analysis in step 806. This process continues until all of the configuration commands have been considered.

It will be recognized that the two techniques described herein above may be combined, as illustrated in the following example:
case test1 no wire_cap net_a

Conventional configuration systems for VLSI circuit analysis tools require an explicit value for any given configuration data. It is not normally possible for a user simply to remove a configuration element from the analysis; rather, the user may override the value of the configuration element with a new value.

An implementation of the invention described herein thus provides system and method to prioritize and selectively apply configuration information for VLSI circuit analysis tools. The embodiments shown and described have been characterized as being illustrative only; it should therefore be readily understood that various changes and modifications could be made therein without departing from the scope of the present invention as set forth in the following claims.

1. A method for use by a circuit analysis tool for selectively applying configuration information from multiple sources to configuration data elements (“CDEs”) stored in a database, the method comprising:
comparing a data source indicator (“DSI”) of a configuration command with a DSI of a corresponding CDE;
if the DSI of the configuration command takes precedence over the DSI of the corresponding CDE, applying the configuration command thereto; and
if the DSI of the configuration command does not take precedence over the DSI of the corresponding CDE, disregarding the configuration command.

2. The method of claim 1 wherein the DSI of the configuration command identifies a source of configuration data included in the configuration command.

3. The method of claim 2 wherein the source identified by the DSI of the configuration command is an external tool.

4. The method of claim 2 wherein the source identified by the DSI of the configuration command is a global configuration file.

5. The method of claim 2 wherein the source identified by the DSI of the configuration command is a user configuration file.

6. The method of claim 5 wherein a DSI identifying a user configuration file as the source of the configuration command has precedence over all other DSIs.

7. The method of claim 1 wherein the configuration command includes a case identifier.

8. The method of claim 7 further comprising:
determining whether the case identifier corresponds to a user-specified analysis case; and
if the case identifier corresponds to the user-specified analysis case, applying the configuration command to the corresponding CDE.

9. The method of claim 8 further comprising, if the case identifier does not correspond to the user-specified analysis case, disregarding the configuration command.

10. The method of claim 1 further comprising:
determining whether the configuration command includes a predetermined prefix; and
if the configuration command includes a predetermined prefix, removing the corresponding configuration data element from the analysis.

11. The method of claim 10 wherein the predetermined prefix is a negative expression.

12. A method for use by a circuit analysis tool for selectively applying configuration information from multiple sources to configuration data elements (“CDEs”) stored in a database, the method comprising:
comparing a case identifier of a configuration command corresponds to a user-specified analysis case; and
if the case identifier corresponds to the user-specified analysis case, applying the configuration command to a corresponding CDE.

13. The method of claim 12 further comprising, if the case identifier does not correspond to the user-specified analysis case, disregarding the configuration command.

14. The method of claim 12 wherein the case identifier identifies an analysis mode of the circuit analysis tool.

15. The method of claim 14 wherein the analysis mode is a power analysis mode.

16. The method of claim 14 wherein the analysis mode is a signal analysis mode.

17. A method for use by a circuit analysis tool for selectively applying configuration information from multiple sources to configuration data elements (“CDEs”) stored in a database, the method comprising:
determining whether a configuration command comprising configuration information to be applied to a corresponding CDE includes a predetermined prefix; and
if the configuration command includes the predetermined prefix, removing the corresponding CDE from the analysis.

18. A method for use by a circuit analysis tool for selectively applying configuration information from multiple sources to configuration data elements (“CDEs”) stored in a database, the method comprising:
determining whether a configuration command to be applied to a corresponding CDE includes a predetermined prefix;
if the configuration command includes a predetermined prefix, removing the corresponding configuration data element from the analysis;
if the configuration command does not include the predetermined prefix, determining whether a case identifier of a configuration command corresponds to a user-specified analysis case;
if the case identifier corresponds to the user-specified analysis case, comparing a data source indicator (“DSI”) of a configuration command with a DSI of a corresponding CDE;
if the DSI of the configuration command takes precedence over the DSI of the corresponding CDE, applying the configuration command thereto; and
if the DSI of the configuration command does not take precedence over the DSI of the corresponding CDE, disregarding the configuration command.

19. The method of claim 18 wherein the DSI of the configuration command identifies a source of configuration data included in the configuration command.

20. The method of claim 19 wherein the source identified by the DSI of the configuration command is an external tool.

21. The method of claim 19 wherein the source identified by the DSI of the configuration command is a global configuration file.

22. The method of claim 19 wherein the source identified by the DSI of the configuration command is a user configuration file.

23. The method of claim 22 wherein a DSI identifying a user configuration file as the source of the configuration command has precedence over all other DSIs.

24. The method of claim 18 wherein the configuration command includes a case identifier.

25. The method of claim 24 further comprising, if the case identifier does not correspond to the user-specified analysis case, disregarding the configuration command.

26. A circuit analysis tool for selectively applying configuration information from multiple sources to configuration data elements (“CDEs”) stored in a database, the tool comprising:
means for comparing a data source indicator (“DSI”) of a configuration command with a DSI of a corresponding CDE;
means for applying the configuration command to the corresponding CDE if the DSI of the configuration command takes precedence over the DSI of the corresponding CDE; and
means for disregarding the configuration command if the DSI of the configuration command does not take precedence over the DSI of the corresponding CDE.

27. The tool of claim 26 wherein the DSI of the configuration command identifies a source of configuration data included in the configuration command.

28. The tool of claim 27 wherein the source identified by the DSI of the configuration command is an external tool.

29. The tool of claim 27 wherein the source identified by the DSI of the configuration command is a global configuration file.

30. The tool of claim 27 wherein the source identified by the DSI of the configuration command is a user configuration file.

31. The tool of claim 30 wherein a DSI identifying a user configuration file as the source of the configuration command has precedence over all other DSIs.

32. The tool of claim 26 further comprising:
means for determining whether a case identifier of the configuration command corresponds to a user-specified analysis case; and
means for applying the configuration command to the corresponding CDE if the case identifier corresponds to the user-specified analysis case.

33. The tool of claim 32 further comprising means for disregarding the configuration command if the case identifier does not correspond to the user-specified analysis case.

34. The tool of claim 26 further comprising:
means for determining whether the configuration command includes a predetermined prefix; and
means for removing the corresponding configuration data element from the analysis if the configuration command includes a predetermined prefix.

35. A circuit analysis tool for selectively applying configuration information from multiple sources to configuration data elements (“CDEs”) stored in a database, the tool comprising:
means for comparing a case identifier of a configuration command corresponds to a user-specified analysis case; and
means for applying the configuration command to a corresponding CDE if the case identifier corresponds to the user-specified analysis case.

36. The tool of claim 35 further comprising means for disregarding the configuration command if the case identifier does not correspond to the user-specified analysis case.

37. A circuit analysis tool for selectively applying configuration information from multiple sources to configuration data elements (“CDEs”) stored in a database, the tool comprising:
means for determining whether a configuration command comprising configuration information to be applied to a corresponding CDE includes a predetermined prefix; and
means for removing the corresponding CDE from the analysis if the configuration command includes the predetermined prefix.

38. A circuit analysis tool for selectively applying configuration information from multiple sources to configuration data elements (“CDEs”) stored in a database, the tool comprising:
means for determining whether a configuration command to be applied to a corresponding CDE includes a predetermined prefix;
means for removing the corresponding configuration data element from the analysis if the configuration command includes a predetermined prefix;
means for determining whether a case identifier of a configuration command corresponds to a user-specified analysis case if the configuration command does not include the predetermined prefix;
means for comparing a data source indicator (“DSI”) of a configuration command with a DSI of a corresponding CDE if the case identifier corresponds to the user-specified analysis case;
means for applying the configuration command to the corresponding CDE if the DSI of the configuration command takes precedence over the DSI of the corresponding CDE; and
means for disregarding the configuration command if the DSI of the configuration command does not take precedence over the DSI of the corresponding CDE.

39. A computer-readable medium operable with a computer for selectively applying configuration information from multiple sources to configuration data elements (“CDEs”) stored in a database of a circuit analysis tool, the medium having stored thereon:
instructions executable by the computer for comparing a data source indicator (“DSI”) of a configuration command with a DSI of a corresponding CDE;
instructions executable by the computer for applying the configuration command to the corresponding CDE if the DSI of the configuration command takes precedence over the DSI of the corresponding CDE; and
instructions executable by the computer for disregarding the configuration command if the DSI of the configuration command does not take precedence over the DSI of the corresponding CDE.

40. The computer-readable medium of claim 39 wherein the DSI of the configuration command identifies a source of configuration data included in the configuration command.

41. The computer-readable medium of claim 40 wherein the source identified by the DSI of the configuration command is an external tool.

42. The computer-readable medium of claim 40 wherein the source identified by the DSI of the configuration command is a global configuration file.

43. The computer-readable medium of claim 40 wherein the source identified by the DSI of the configuration command is a user configuration file.

44. The computer-readable medium of claim 43 wherein a DSI identifying a user configuration file as the source of the configuration command has precedence over all other DSIs.

45. The computer-readable medium of claim 39 further having stored thereon:
instructions executable by the computer for determining whether a case identifier of the configuration command corresponds to a user-specified analysis case; and
instructions executable by the computer for applying the configuration command to the corresponding CDE if the case identifier corresponds to the user-specified analysis case.

46. The computer-readable medium of claim 45 further having stored thereon instructions executable by the computer for disregarding the configuration command if the case identifier does not correspond to the user-specified analysis case.

47. The computer-readable medium of claim 39 further having stored thereon:
instructions executable by the computer for determining whether the configuration command includes a predetermined prefix; and
instructions executable by the computer for removing the corresponding configuration data element from the analysis if the configuration command includes a predetermined prefix.

48. A computer-readable medium operable with a computer for selectively applying configuration information from multiple sources to configuration data elements (“CDEs”) stored in a database of a circuit analysis tool, the medium having stored thereon:
instructions executable by the computer for comparing a case identifier of a configuration command corresponds to a user-specified analysis case; and
instructions executable by the computer for applying the configuration command to a corresponding CDE if the case identifier corresponds to the user-specified analysis case.

49. The computer-readable medium of claim 48 further having stored thereon instructions executable by the computer for disregarding the configuration command if the case identifier does not correspond to the user-specified analysis case.

50. A computer-readable medium operable with a computer for selectively applying configuration information from multiple sources to configuration data elements (“CDEs”) stored in a database of a computer-readable medium analysis tool, the medium having stored thereon:
instructions for determining whether a configuration command comprising configuration information to be applied to a corresponding CDE includes a predetermined prefix; and
instructions executable by the computer for removing the corresponding CDE from the analysis if the configuration command includes the predetermined prefix.

51. A computer-readable medium operable with a computer for selectively applying configuration information from multiple sources to configuration data elements (“CDEs”) stored in a database of a computer-readable medium analysis tool, the medium having stored thereon:
instructions executable by the computer for determining whether a configuration command to be applied to a corresponding CDE includes a predetermined prefix;
instructions executable by the computer for removing the corresponding configuration data element from the analysis if the configuration command includes a predetermined prefix;
instructions executable by the computer for determining whether a case identifier of a configuration command corresponds to a user-specified analysis case if the configuration command does not include the predetermined prefix;
instructions executable by the computer for comparing a data source indicator (“DSI”) of a configuration command with a DSI of a corresponding CDE if the case identifier corresponds to the user-specified analysis case;
instructions executable by the computer for applying the configuration command to the corresponding CDE if the DSI of the configuration command takes precedence over the DSI of the corresponding CDE; and
instructions executable by the computer for disregarding the configuration command if the DSI of the configuration command does not take precedence over the DSI of the corresponding CDE.
